(19) United States
(12) Patent Application Publication
(10) Pub. No.: US 2020/0065025 A1
(43) Pub. Date: Feb. 27, 2020

(54) MEMORY CONTROLLER, STORAGE DEVICE, AND OPERATING METHOD THEREOF

(71) Applicant: SK hynix Inc., Gyeonggi-do (KR)

(72) Inventor: Jiman HONG, Gyeonggi-do (KR)

(21) Appl. No.: 16/365,957

(22) Filed: Mar. 27, 2019

(30) Foreign Application Priority Data
Aug. 21, 2018 (KR) 10-2018-0097653

(51) Int. Cl. G06F 3/06

(52) U.S. Cl. CPC G06F 3/0656; G06F 3/0614; G06F 3/0679

(57) ABSTRACT

A memory controller transferring first program data to a semiconductor memory device to control a program operation of the semiconductor memory device may include a buffer memory and a data change detector. The buffer memory may store second program data received from the semiconductor memory device after the first program data is transferred. The data change detector may determine whether the first data transferred to the semiconductor memory device is changed by analyzing the second program data.

### CROSS-REFERENCE TO RELATED APPLICATION

The present application claims priority under 35 U.S.C. § 119(a) to Korean patent application number 10-2018-0097653, filed on Aug. 21, 2018, which is incorporated by reference in its entirety.

### BACKGROUND

### 1. Field of Invention

Various embodiments generally relate to an electronic device. Particularly, the embodiments relate to a memory controller, a storage device, and an operating method thereof.

### 2. Description of Related Art

A memory device may have a two-dimensional structure in which strings are arranged horizontally with respect to a semiconductor substrate, or a three-dimensional structure in which the strings are arranged vertically with respect to the semiconductor substrate. A three-dimensional semiconductor device is a memory device devised to overcome integration limitations of a two-dimensional semiconductor device, and may include a plurality of memory cells vertically stacked on a semiconductor substrate.

A memory controller may control operations of a memory device.

### SUMMARY

An embodiment provides a memory controller having improved reliability and a storage device including the same.

Another embodiment provides a method of operating a memory controller having improved reliability.

According to an embodiment, a memory controller transferring first program data to a semiconductor memory device to control a program operation of the semiconductor memory device may include a buffer memory and a data change detector. The buffer memory may store second program data received from the semiconductor memory device after the first program data is transferred. The data change detector may determine whether the first program data transferred to the semiconductor memory device is changed by analyzing the second program data.

The memory controller may transfer a data output command to the semiconductor memory device after transferring the first program data to the semiconductor memory device. The memory controller may receive the second program data from the semiconductor memory device in response to the data output command.

The buffer memory may include an original data storage and a reception data storage. The original data storage may store the first program data. The reception data storage may store the second program data.

The data change detector may include a data comparator comparing the first program data with the second program data.

The data comparator may determine that the data is changed when a number of different bits between the first program data and the second program data is greater than or equal to a first threshold value.

The buffer memory may include a reception data storage storing the second program data. The data change detector may include an error correction code (ECC) block performing an error correction operation on the second program data.

The ECC block may count error bits included in the second program data and determine that the data is changed when a number of error bits is greater than or equal to a second threshold value.

According to another embodiment, a storage device may include a first semiconductor memory device, a second semiconductor memory device, and a memory controller. The second semiconductor memory device may share a channel with the first semiconductor memory device. The memory controller may control the first and second semiconductor memory devices through the channel. The memory controller may be configured to: transfer a first program command and first program data to the first semiconductor memory device, transfer a second program command and second program data to the second semiconductor memory device, and output a data output command to one of the first and second semiconductor memory devices during an idle time of the channel when a first program operation of the first semiconductor memory device and a second program operation of the second semiconductor memory device are performed in response to the first program command and the second program command, respectively.

The memory controller may include a buffer memory and a data change detector. The buffer memory may store third program data corresponding to the data output command. The data change detector may determine whether data is changed by analyzing the third program data.

The buffer memory may include an original data storage and a reception data storage. The original data storage may store at least one of the first program data and the second program data. The reception data storage may store the third program data.

The memory controller may transfer the data output command to the first semiconductor memory device. The original data storage may store the third program data received from the first semiconductor memory device. The data change detector may include a data comparator comparing the first program data with the third program data to determine that the data is changed when a number of different bits is greater than or equal to a first threshold value.

The memory controller may transfer the data output command to the second semiconductor memory device. The original data storage may store the third program data received from the second semiconductor memory device. The data change detector may include a data comparator comparing the second program data with the third program data to determine that the data is changed when a number of different bits is greater than or equal to a first threshold value.

The buffer memory may include a reception data storage storing the third program data. The data change detector may count error bits included in the third program data and determine that the data is changed when a number of error bits is greater than or equal to a second threshold value.

According to another embodiment, a method of operating a memory controller may include transferring a program command and first program data to a semiconductor memory device, transferring a data output command to the semiconductor memory device, receiving second program data from the semiconductor memory device, and determining whether the first program data transferred to the semiconductor device is changed by analyzing the second program data.

The determining whether the program data is changed may include comparing the first program data with the second program data, and determining that the program data is changed when a number of different bits between the first program data and the second program data is greater than or equal to a first threshold value.

The determining whether the program data is changed may include determining an error correction operation on the second program data, and determining that the program data is changed when a number of detected error bits is greater than or equal to a second threshold value as a result of performing the error correction operation.

According to another embodiment, a method of operating a memory controller may include controlling operations of a plurality of semiconductor memory devices sharing a channel. The method may include transferring program data and a program command corresponding to each of the plurality of semiconductor memory devices, checking a state of the channel, transferring a data output command to one of the plurality of semiconductor memory devices when the channel is in an idle state, receiving program data corresponding to the data output command, and checking whether the program data transferred to the one of the semiconductor memory devices is changed by analyzing the program data.

The data output command may be transferred only when each of the plurality of semiconductor memory devices sharing the channel performs a program operation.

The checking may include comparing the program data of the receiving operation (reception data) with the program data of the transferring operation (original data), and determining that the program data is changed by comparing the reception data with original data when a number of different bits between the reception data and the original data is greater than or equal to a first threshold value.

The checking may include performing an error correction operation on the program data; and determining that the program data is changed when a number of error bits is greater than or equal to a second threshold value as a result of the error correction operation.

According to another embodiment, a memory system may include a plurality of memory devices and a controller. The plurality of memory devices may share a channel. The controller may be configured to control, through the channel, the memory devices to program plural pieces of data based on an interleaving scheme. The controller detects bit-flips in the data received back from the memory devices to provide corrected pieces of the data to the memory devices, respectively, while the memory devices are programming the data and the channel is idle.

### BRIEF DESCRIPTION OF THE DRAWINGS

FIG. 1 is a block diagram illustrating a storage device including a memory controller according to an embodiment;

FIG. 2 is a block diagram illustrating a semiconductor memory device such as that shown in FIG. 1;

FIG. 3 shows an embodiment of a memory cell array such as that shown in FIG. 2;

FIG. 4 is a circuit diagram illustrating an embodiment of a memory block BLKa, which is one of the memory blocks BLK1 to BLKz shown in FIG. 3;

FIG. 5 is a circuit diagram illustrating another embodiment of a memory block BLKb, which is one of the memory blocks BLK1 to BLKz shown in FIG. 3;

FIG. 6 is a circuit diagram illustrating an embodiment of a memory block BLKc, which is one of the memory blocks BLK1 to BLKz included in a memory cell array 110 shown in FIG. 2;

FIG. 7 is a block diagram illustrating a memory controller 200 according to an embodiment;

FIG. 8 is a block diagram illustrating an embodiment of a buffer memory and a data change detector of FIG. 7 according to an embodiment;

FIGS. 9A to 9D are block diagrams illustrating operations of a memory controller 200 shown in FIG. 8 according to an embodiment;

FIG. 10 is a block diagram illustrating another embodiment of a buffer memory and a data change detector of FIG. 7 according to an embodiment;

FIGS. 11A to 11E are block diagrams illustrating operations of the memory controller 200 shown in FIG. 10 according to an embodiment;

FIG. 12 is a flowchart illustrating a method of operating the memory controller 200 according to an embodiment;

FIG. 13A is a flowchart illustrating an embodiment of step S110 of FIG. 12;

FIG. 136 is a flowchart illustrating an embodiment of step S150 of FIG. 12;

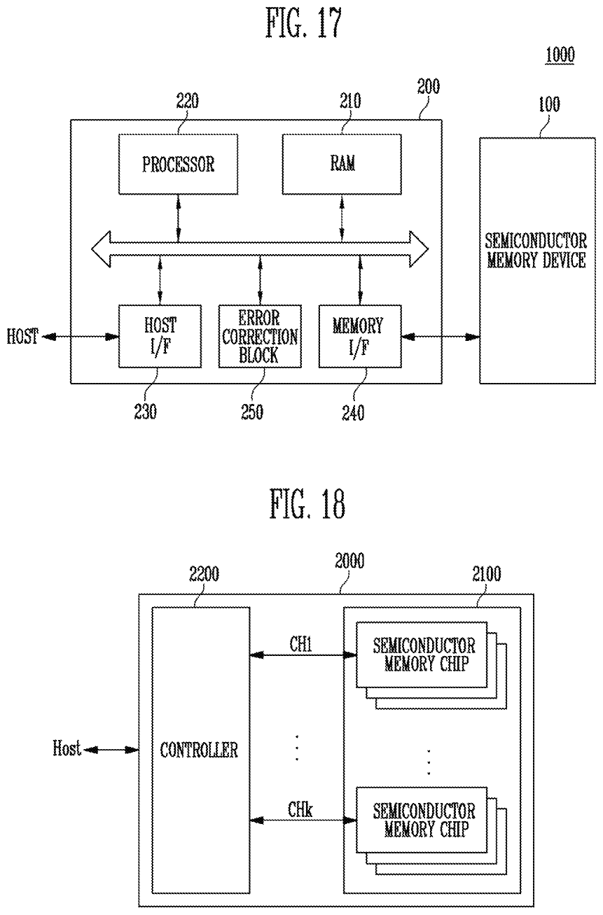

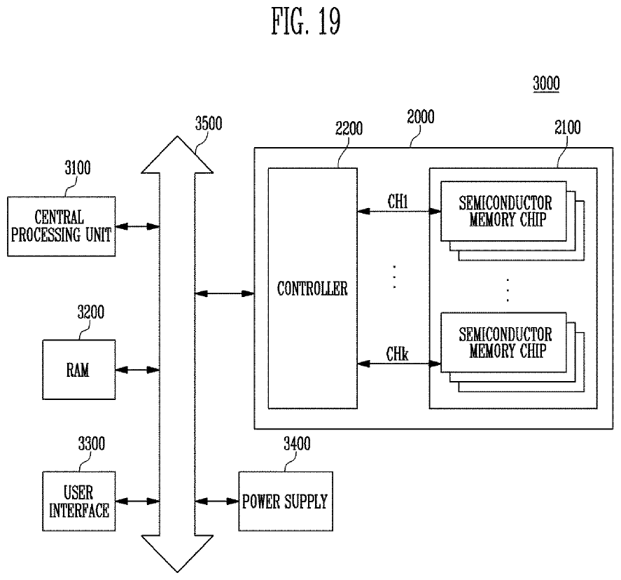

FIG. 13C is a flowchart illustrating an embodiment of step S170 of FIG. 12;

FIG. 13D is a flowchart illustrating another embodiment of step S170 of FIG. 12;

FIG. 14 is a block diagram illustrating a storage device 1001 according to an embodiment;

FIG. 15 is a timing diagram illustrating operations of a storage device shown in FIG. 14 according to an embodiment;

FIG. 16 is flowchart illustrating a method of operating a storage device shown in FIG. 14 according to an embodiment;

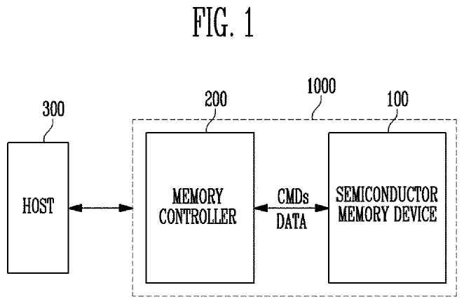

FIG. 17 is a block diagram illustrating an embodiment of the memory controller 200 shown in FIG. 1;

FIG. 18 is a block diagram illustrating an application example of a storage device of FIG. 1; and

FIG. 19 is a block diagram illustrating a computing system including a storage device described with reference to FIG. 18 according to an embodiment.

### DETAILED DESCRIPTION

Various embodiments will now be described more fully with reference to the accompanying drawings. However, elements and features may be configured or arranged differently than disclosed herein. Thus, the present disclosure is not limited to the embodiments set forth herein. Rather, these embodiments are provided so that this disclosure is thorough and complete and fully conveys the scope of the embodiments to those skilled in the art. Throughout the specification, reference to “an embodiment,” “another embodiment,” or the like is not necessarily to only one embodiment, and different references to any such phrase are not necessarily to the same embodiment(s).

It will be understood that when an element is referred to as being “coupled” or “connected” to a certain element, it may be directly coupled or connected to the certain element, or may be indirectly coupled or connected to the certain element with one or more intervening elements therebetween. Whether two elements are directly or indirectly connected or coupled, communication between the elements may be wired or wireless, unless specifically stated or the context indicates otherwise. In the specification, when an element is referred to as “comprising” or “including” a component, such open ended phrase does not exclude the presence or addition of one or more other components, unless specifically stated or the context indicates otherwise.

It will be understood that, although the terms “first”, “second”, “third”, and so on may be used herein to describe various elements, these elements are not limited by these terms. These terms are used to distinguish one element from another element. Thus, a first element described below could also be termed as a second or third element without departing from the spirit and scope of the present invention.

As used herein, singular forms may include the plural forms as well and vice versa, unless the context clearly indicates otherwise. The articles ‘a’ and ‘an’ as used in this application and the appended claims should generally be construed to mean ‘one or more’ unless specified otherwise or clear from context to be directed to a singular form.

In the drawings, like reference numerals refer to like elements throughout. In some embodiments, well-known processes, device structures, and technologies will not be described in detail to avoid unnecessarily obscuring elements and features.

FIG. 1 is a block diagram illustrating a storage device 1000 including a memory controller 200 according to an embodiment.

Referring to FIG. 1, the storage device 1000 may include a semiconductor memory device 100 and the memory controller 200. In addition, the storage device 1000 may communicate with a host 300. In addition, the memory controller 200 may control general operations of the semiconductor memory device 100 by transferring commands CMDs on the basis of requests received from the host 300. In addition, the memory controller 200 may transfer data DATA corresponding to each of the commands CMDs to the semiconductor memory device 100, or may receive data from the semiconductor memory device 100. For example, when the memory controller 200 receives a program request and program data from the host 300, the memory controller 200 may transfer a program command and the program data to the semiconductor memory device 100. In another example, when the memory controller 200 receives a read request from the host 300, the memory controller 200 may transfer a read command corresponding to the read request to the semiconductor memory device 100. The semiconductor memory device 100 may transfer read data corresponding to the read command to the memory controller 200.

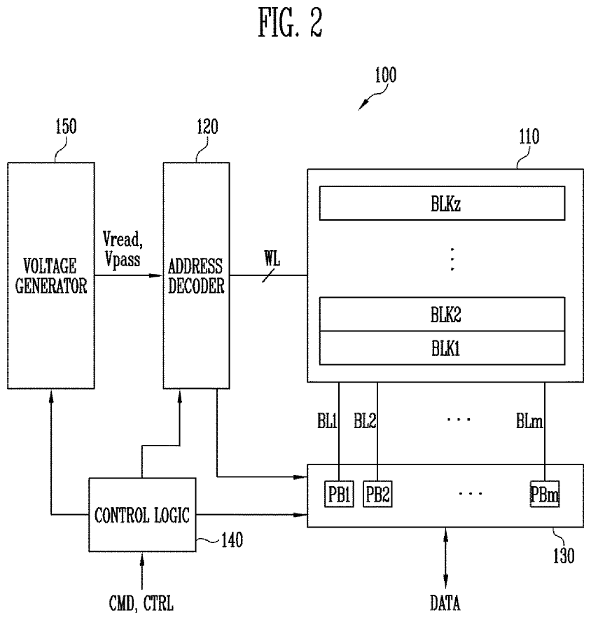

Program data may be transferred from the memory controller 200 to the semiconductor memory device 100 for a program operation. The program data may be stored in a page buffer of the semiconductor memory device 100. The page buffer may be included in a read and write circuit of the semiconductor memory device 100. The read and write circuit and the page buffer will be described below with reference to FIG. 2. Memory cells included in the semiconductor memory device 100 may be programmed with the program data stored in the page buffer.

When the program data is transferred to the page buffer from the memory controller 200, or when the program data is stored in the page buffer, bit flips may occur. Bit flips are a type of data errors. When bit flips occur, values of some of the bits included in data are changed. If bit flips occur when the program data is transferred to the page buffer, the memory cells of the semiconductor memory device may be programmed with program data including errors, which may cause deterioration in reliability of the semiconductor memory device and the storage device including the same.

According to an embodiment of the invention, the memory controller 200 may transfer a program command and program data corresponding thereto to the semiconductor memory device 100 so as to control a program operation of the semiconductor memory device 100. After the memory controller 200 transfers the program data, the memory controller 200 may transfer a data output command to the semiconductor memory device 100. In response to the data output command, the semiconductor memory device 100 may transfer the program data stored in the page buffer to the memory controller 200.

The memory controller 200 may determine whether the program data is changed or not by analyzing the program data received from the semiconductor memory device 100. The program data provided from the semiconductor memory device 100 to the memory controller 200 may be data stored in the page buffer of the semiconductor memory device 100. By analyzing the program data from the semiconductor memory device 100, whether bit flips have occurred may be determined. When bit flips occurred, the memory controller 200 may transfer the same program data to the semiconductor memory device 100 again and control the semiconductor memory device 100 to program the re-transferred data. Therefore, the reliability of the semiconductor memory device 100 and the storage device 1000 including the same may be improved.

FIG. 2 is a block diagram illustrating the semiconductor memory device 100 shown in FIG.

Referring to FIG. 2, the semiconductor memory device 100 may include a memory cell array 110, an address decoder 120, a read and write circuit 130, a control logic 140, and a voltage generator 150.

The memory cell array 110 may include a plurality of memory blocks BLK1 to BLKz. The plurality of memory blocks BLK1 to BLKz may be coupled to the address decoder 120 through word lines WL. The plurality of memory blocks BLK1 to BLKz may be coupled to the read and write circuit 130 through bit lines BL1 to BLm. Each of the plurality of memory blocks BLK1 to BLKz may include a plurality of memory cells. According to an embodiment, the plurality of memory cells may be non-volatile memory cells having a vertical channel structure. The memory cell array 110 may have a two-dimensional structure. According to an embodiment, the memory cell array 110 may have a three-dimensional structure. Each of the plurality of memory cells included in the memory cell array 110 may store data of at least 1-bit. According to an embodiment, each of the plurality of memory cells included in the memory cell array 110 may be a single-level cell (SLC) storing 1-bit data. According to another embodiment, each of the plurality of memory cells included in the memory cell array 110 may be a multi-level cell (MLC) storing 2-bit data. According to another embodiment, each of the plurality of memory cells included in the memory cell array 110 may be a triple-level cell (TLC) storing 3-bit data. According to another embodiment, each of the plurality of memory cells included in the memory cell array 110 may be a quad-level cell (QLC) storing 4-bit data. According to an embodiment, each of the plurality of memory cells included in the memory cell array 110 may store five or more bits of data.

The address decoder 120, the read and write circuit 130 and the control logic 150 may operate as a peripheral circuit configured to the memory cell array 110. The address decoder 120 may be coupled to the memory cell array 110 through the word lines WL. The address decoder 120 may be controlled by the control logic 140. The address decoder 120 may receive an address through an input/output buffer (not illustrated) in the semiconductor memory device 100.

The address decoder 120 may be configured to decode a block address of the received address. The address decoder 120 may select at least one memory block according to the decoded block address. In addition, during a read voltage applying operation of a read operation, the address decoder 120 may apply a read voltage Vread generated by the voltage generator 150 to a selected word line of a selected memory block and may apply a pass voltage Vpass to unselected word lines. In addition, during a program verify operation, a verify voltage generated by the voltage generator 150 may be applied to the selected word line of the selected memory block and a pass voltage Vpass may be applied to the unselected word lines.

The address decoder 120 may be configured to decode a column address of the received address. The address decoder 120 may transfer the decoded column address to the read and write circuit 130.

A read operation and a program operation of the semiconductor memory device 100 may be performed in units of pages. An address received at the request of a read operation and a program operation may include a block address, a row address, and a column address. The address decoder 120 may select one memory block and one word line in response to the block address and the row address. The column address may be decoded by the address decoder 120 and provided to the read and write circuit 130.

The address decoder 120 may include a block decoder, a row decoder, a column decoder, and an address buffer.

The read and write circuit 130 may include a plurality of page buffers PB1 to PBm. The read and write circuit 130 may operate as a read circuit during a read operation of the memory cell array 110 and a write circuit during a write operation thereof. The page buffers PB1 to PBm may be coupled to the memory cell array 110 through the bit lines BL1 to BLm. The page buffers PB1 to PBm may continuously supply a sensing current to bit lines coupled to memory cells in order to sense threshold voltages of the memory cells and sense changes in amount of current caused by program states of the memory cells corresponding thereto through a sensing node to latch sensing data during a read operation and a program verify operation. The read and write circuit 130 may operate in response to page buffer control signals output from the control logic 140.

The read and write circuit 130 may sense data of a memory cell, temporarily store the read data, and output the data to an input/output buffer (not illustrated) of the semiconductor memory device 100 during a read operation. According to an embodiment, the read and write circuit 130 may include a column selection circuit in addition to the page buffers PB1 to PBm (or page registers).

The control logic 140 may be coupled to the address decoder 120, the read and write circuit 130, and the voltage generator 150. The control logic 140 may receive a command CMD and a control signal CTRL through the input/output buffer (not illustrated) of the semiconductor memory device 100. The control logic 140 may be configured to control general operations of the semiconductor memory device 100 in response to the control signal CTRL. In addition, the control logic 140 may output a control signal to control sensing node precharge potential levels of the page buffers PB1 to PBm. The control logic 140 may control the read and write circuit 130 to perform a read operation of the memory cell array 110.

The voltage generator 150 may generate the read voltage Vread and the pass voltage Vpass in response to a control signal output from the control logic 140 during a read operation. The voltage generator 150 may include a plurality of pumping capacitors receiving an internal power voltage to generate a plurality of voltages having various voltage levels, and may generate a plurality of voltages by selectively activating the plurality of pumping capacitors in response to control of the control logic 140. As described above, the voltage generator 150 may include a charge pump, which may include the above-described pumping capacitors. The specific configuration of the charge pump included in the voltage generator 150 may be variously designed.

The address decoder 120, the read and write circuit 130, and the voltage generator 150 may function as a ‘peripheral circuit’ configured to perform a read operation, a write operation, and an erase operation on the memory cell array 110. The control logic 140 may control the peripheral circuit to perform the read operation, the write operation, and the erase operation on the memory cell array 110.

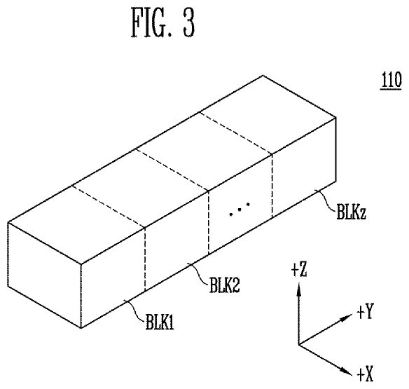

FIG. 3 shows an embodiment of the memory cell array 110 shown in FIG. 2.

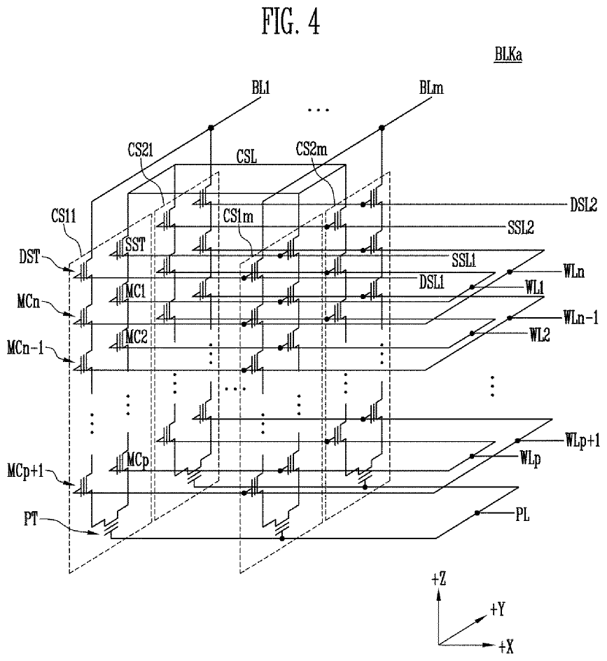

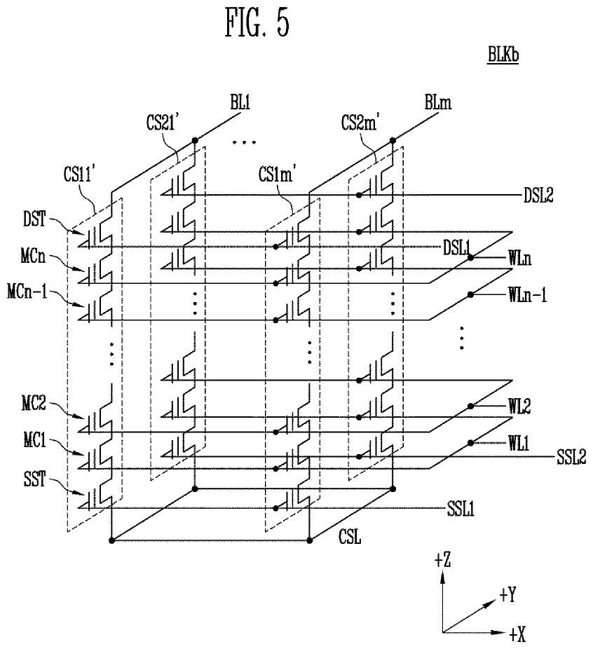

Referring to FIG. 3, the memory cell array 110 may include the plurality of memory blocks BLK1 to BLKz. Each of the memory blocks BLK1 to BLKz may include a three-dimensional structure. Each memory block may include a plurality of memory cells stacked over a substrate. The plurality of memory cells may be arranged in +X direction, +Y direction and +Z direction. The structure of each memory block will be described in detail below with reference to FIGS. 4 and 5.

FIG. 4 is a circuit diagram illustrating one memory block BLKa of the memory blocks BLK1 to BLKz shown in FIG. 3. The memory block BLKa may correspond to any one memory block among the memory blocks BLK1 to BLKz shown in FIGS. 2 and 3.

Referring to FIG. 4, the memory block BLKa may include a plurality of cell strings CS11 to CS1m and CS21 to CS2m. According to an embodiment, each of the cell strings CS11 to CS1m and CS21 to CS2m may be formed in a U shape. In the memory block BLKa, ‘m’ cell strings may be arranged in a row direction (i.e., +X direction). In FIG. 4, it is illustrated that two cell strings are arranged in a column direction (i.e., +Y direction). However, it is understood that three or more cell strings may be arranged in the column direction.

Each of the cell strings CS11 to CS1m and CS21 to CS2m may include at least one source select transistor SST, first to nth memory cells MC1 to MCn, a pipe transistor PT, and at least one drain select transistor DST.

Each of the select transistors SST and DST and each of the memory cells MC1 to MCn may have similar structures to each other. According to an embodiment, each of the select transistors SST and DST and the memory cells MC1 to MCn may include a channel layer, a tunneling insulating layer, a charge storage layer, and a blocking insulating layer. According to an embodiment, a pillar for providing a channel layer may be provided in each cell string. According to an embodiment, a pillar for providing at least one of the channel layer, the tunneling insulating layer, the charge storage layer, and the blocking insulating layer may be provided in each cell string.

The source select transistor SST of each cell string may be coupled between a common source line CSL and memory cells MC1 to MCp.

According to an embodiment, source select transistors of cell strings arranged in the same row may be coupled to a source select line extending in a row direction, and source select transistors of cell strings arranged in different rows may be coupled to different source select lines. In FIG. 4, source select transistors of the cell strings CS11 to CS1m in the first row may be coupled to a first source select line SSL1. Source select transistors of the cell strings CS21 to CS2m in the second row may be coupled to a second source select line SSL2.

According to another embodiment, the source select transistors of the cell strings CS11 to CS1m and CS21 to CS2m may be coupled in common to one source select line.

The first to nth memory cells MC1 to MCn of each cell string may be coupled between the source select transistor SST and the drain select transistor DST.

The first to nth memory cells MC1 to MCn may be divided into first to pth memory cells MC1 to MCp and (p+1)th to nth memory cells MCp+1 to MCn. The first to pth memory cells MC1 to MCp may be sequentially arranged in a −Z direction and may be coupled in series between the source select transistor SST and the pipe transistor PT. The (p+1)th to nth memory cells MCp+1 to MCn may be sequentially arranged in the +Z direction and may be coupled in series between the pipe transistor PT and the drain select transistor DST. The first to pth memory cells MC1 to MCp and the (p+1)th to nth memory cells MCp+1 to MCn may be coupled through the pipe transistor PT. Gates of the first to nth memory cells MC1 to MCn of each cell string may be coupled to first to nth word lines WL1 to WLn, respectively.

A gate of the pipe transistor PT of each cell string may be coupled to a pipe line PL.

The drain select transistor DST of each cell string may be coupled between the corresponding bit line and the memory cells MCp+1 to MCn. Cell strings arranged in the row direction may be coupled to a drain select line extending in the row direction. Drain select transistors of the cell strings CS11 to CS1m in the first row may be coupled to a first drain select line DSL1. Drain select transistors of the cell strings CS21 to CS2m in the second row may be coupled to a second drain select line DSL2.

Cell strings arranged in the column direction may be coupled to a bit line extending in the column direction. In FIG. 4, the cell strings CS11 and CS21 in a first column may be coupled to the first bit line BL1. The cell strings CS1m and CS2m in an mth column may be coupled to the mth bit line BLm.

Memory cells coupled to the same word line arranged in cell strings arranged in the row direction may form a single page. For example, memory cells coupled to the first word line WL1 in the cell strings CS11 to CS1m in the first row may constitute a single page. Memory cells coupled to the first word line WL1 in the cell strings CS21 to CS2m in the second row may constitute another page. When one of the drain select lines DSL1 and DSL2 is selected, cell strings arranged in the row direction may be selected. When one of the first to nth word lines WL1 to WLn is selected, one page may be selected from the selected cell strings.

In another embodiment, even bit lines and odd bit lines may be provided instead of the first to mth bit lines BL1 to BLm. In addition, even cell strings of the cell strings CS11 to CS1m or CS21 to CS2m arranged in the row direction may be coupled to even bit lines, respectively, and odd cell strings of the cell strings CS11 to CS1m or CS21 to CS2m arranged in the row direction may be coupled to odd bit lines, respectively.

According to an embodiment, at least one of the first to nth memory cells MC1 to MCn may serve as a dummy memory cell. For example, one or more dummy memory cells may be provided to reduce an electric field between the source select transistor SST and the memory cells MC1 to MCp. Alternatively, one or more dummy memory cells may be provided to reduce an electric field between the drain select transistor DST and the memory cells MCp+1 to MCn. When more dummy memory cells are provided, the operational reliability of the memory block BLKa may increase, whereas the size of the memory block BLKa may increase. On the other hand, when the number of dummy memory cells decreases, the size of the memory block BLKa may be reduced, and the operational reliability of the memory block BLKa may be reduced.

In order to efficiently control one or more dummy memory cells, each of the dummy memory cells may have a required threshold voltage. Before or after an erase operation on the memory block BLKa, program operations may be performed on a portion or entirety of the dummy memory cells. When an erase operation is performed after a program operation is performed, the dummy memory cells may have required threshold voltages by controlling a voltage applied to dummy word lines coupled to the dummy memory cells.

FIG. 5 is a circuit diagram illustrating another embodiment of a memory block BLKb, which is one of the memory blocks BLK1 to BLKz shown in FIG. 3. The memory block BLKb may correspond to any one memory block among the memory blocks BLK1 to BLKz shown in FIGS. 2 and 3.

Referring to FIG. 5, the memory block BLKb may include a plurality of cell strings CS11′ to CS1m′ and CS21′ to CS2m′. Each of the plurality of cell strings CS11′ to CS1m′ and CS21′ to CS2m′ may extend in the +Z direction. Each of the plurality of cell strings CS11′ to CS1m′ and CS21′ to CS2m′ may include at least one source select transistor SST, the first to nth memory cells MC1 to MCn, and at least one drain select transistor DST, which are stacked on a substrate (not shown) under a memory block BLK1′.

The source select transistor SST of each cell string may be coupled between the common source line CSL and the first to nth memory cells MC1 to MCn. Source select transistors of cell strings arranged in the same row may be coupled to the same source select line. Source select transistors of the cell strings CS11′ to CS1m′ arranged in the first row may be coupled to the first source select line SSL1. Source select transistors of the cell strings CS21′ to CS2m′ arranged in the second row may be coupled to the second source select line SSL2. According to another embodiment, the source select transistors of the cell strings CS11′ to CS1m′ and CS21′ to CS2m′ may be commonly coupled to a single source select line.

The first to nth memory cells MC1 to MCn of each cell string may be coupled in series between the source select transistor SST and the drain select transistor DST. Gates of the first to nth memory cells MC1 to MCn may be coupled to the first to nth word lines WL1 to WLn, respectively.

The drain select transistor DST of each cell string may be coupled between the corresponding bit line and the memory cells MC1 to MCn. Drain select transistors of cell strings arranged in the row direction may be coupled to a drain select line extending in the row direction. Drain select transistors of the cell strings CS11′ to CS1m′ in the first row may be coupled to the first drain select line DSL1. Drain select transistors of the cell strings CS21′ to CS2m′ in the second row may be coupled to the second drain select line DSL2.

As a result, the memory block BLKb shown in FIG. 5 may have a circuit similar to that of the memory block BLKa shown in FIG. 4, except that the pipe transistor PT is removed from each cell string of the memory block BLKb.

In another embodiment, even bit lines and odd bit lines may be provided instead of the first to mth bit lines BL1 to BLm. In addition, even cell strings of the cell strings CS11′ to CS1m′ or CS21′ to CS2m′ arranged in the row direction may be coupled to the even bit lines, respectively, and odd cell strings of the cell strings CS11′ to CS1m′ or CS21′ to CS2m′ arranged in the row direction may be coupled to the odd bit lines, respectively.

According to an embodiment, at least one of the first to nth memory cells MC1 to MCn may serve as a dummy memory cell. For example, one or more dummy memory cells may be provided to reduce an electric field between the source select transistor SST and the first to nth memory cells MC1 to MCn. Alternatively, one or more dummy memory cells may be provided to reduce an electric field between the drain select transistor DST and the memory cells MC1 to MCn. When more dummy memory cells are provided, the operational reliability of the memory block BLKb may increase, whereas the size of the memory block BLKb may increase. When fewer memory cells are provided, the size of the memory block BLKb may be reduced and the operational reliability of the memory block BLKb may be degraded.

In order to efficiently control one or more dummy memory cells, each of the dummy memory cells may have a required threshold voltage. Before or after an erase operation on the memory block BLKb, program operations may be performed on a portion or entirety of the dummy memory cells. When an erase operation is performed after a program operation is performed, the dummy memory cells may have required threshold voltages by controlling a voltage applied to dummy word lines coupled to the dummy memory cells.

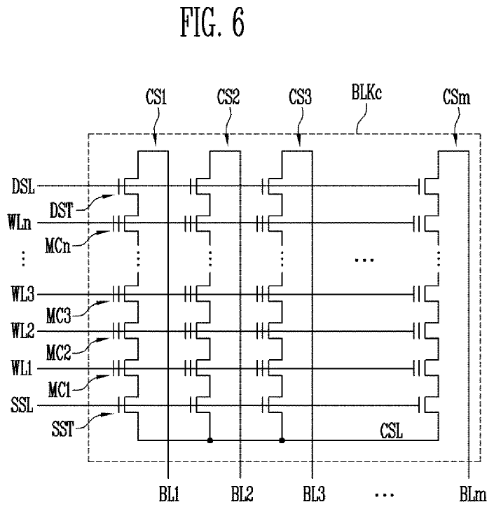

FIG. 6 is a circuit diagram illustrating an embodiment of a memory block BLKc, which is one of the memory blocks BLK1 to BLKz included in the memory cell array 110 shown in FIG. 2. The memory block BLKc may correspond to any one memory block among the memory blocks BLK1 to BLKz shown in FIG. 2.

Referring to FIG. 6, the memory block BLKc may include a plurality of cell strings CS1 to CSm. The plurality of cell strings CS1 to CSm may be coupled to the plurality of bit lines BL1 to BLm, respectively. Each of the cell strings CS1 to CSm may include at least one source select transistor SST, the first to nth memory cells MC1 to MCn, and at least one drain select transistor DST.

Each of the selection transistors SST and DST and each of the memory cells MC1 to MCn may have similar structures to each other. According to an embodiment, each of the select transistors SST and DST and the memory cells MC1 to MCn may include a channel layer, a tunneling insulating layer, a charge storage layer, and a blocking insulating layer. According to an embodiment, a pillar for providing a channel layer may be provided in each cell string. According to an embodiment, a pillar for providing at least one of the channel layer, the tunneling insulating layer, the charge storage layer, and the blocking insulating layer may be provided to each cell string.

The source select transistor SST of each cell string may be coupled between the common source line CSL and the first to nth memory cells MC1 to MCn.

The first to nth memory cells MC1 to MCn of each cell string may be coupled between the source select transistor SST and the drain select transistor DST.

The drain select transistor DST of each cell string may be coupled between a corresponding bit line and the memory cells MC1 to MCn.

Memory cells coupled to the same word line may form a single page. When the drain select line DSL is selected, the cell strings CS1 to CSm may be selected. When one of the word lines WL1 to WLn is selected, one page may be selected from selected cell strings.

In another embodiment, even bit lines and odd bit lines may be provided instead of the first to mth bit lines BL1 to BLm. Even cell strings of the cell strings CS1 to CSm may be coupled to the even bit lines, respectively, and odd cell strings thereof may be coupled to the odd bit lines, respectively.

FIG. 7 is a block diagram illustrating the memory controller 200 according to an embodiment.

Referring to FIG. 7, the memory controller 200 may include a buffer memory 410 and a data change detector 430. The buffer memory 410 may store reception program data output from the semiconductor memory device 100 in response to a data output command. The data change detector 430 may determine whether or not the program data has been changed (i.e., one or more bits have been flipped) by analyzing the reception program data stored in the buffer memory 410.

During a program operation, the memory controller 200 may transfer a program command and program data to the semiconductor memory device 100. The semiconductor memory device 100 may store the received program data in the read and write circuit 130. More specifically, the program data may be stored in page buffers (for instance, page buffers PB1 to PBm) of the read and write circuit 130 shown in FIG. 2. After the memory controller 200 transfers the program command and the program data to the semiconductor memory device 100, the memory controller 200 may transfer a data output command to the semiconductor memory device 100. The data output command may be used to perform a read operation of the semiconductor memory device 100. The data output command may be transferred in order to control the semiconductor memory device 100 so that the program data stored in the page buffers in the read and write circuit 130 is output to the memory controller 200.

As the data output command is transferred, the semiconductor memory device 100 may output the program data stored in the page buffers of the read and write circuit 130 to the memory controller 200. The memory controller 200 may determine whether or not the received program data has been changed by analyzing the program data received from the semiconductor memory device 100, i.e., the reception program data.

For convenience of explanation, the program data output from the memory controller 200 may be referred to as “original data” and the program data received by the memory controller 200 in response to the data output command may be referred to as “reception data”. The original data may refer to data before bit flips occur and may not have any errors. The reception data may refer to the original data which is transferred to the semiconductor memory device 100, stored in the page buffers of the read and write circuit 130, and transferred back to the memory controller 200. The reception data may include errors caused by bit-flips.

According to an embodiment, the memory controller 200 may analyze the reception data to determine whether or bit flips occurred relative to the original data. When it is determined that one or more bit flips occurred, the memory controller 200 may transfer the original data again to the semiconductor memory device 100 and control the semiconductor memory device 100 to perform a program operation again. Therefore, data with no errors may be programmed into memory cells, so that the reliability of the semiconductor memory device 100 and the storage device 1000 including the same may be improved.

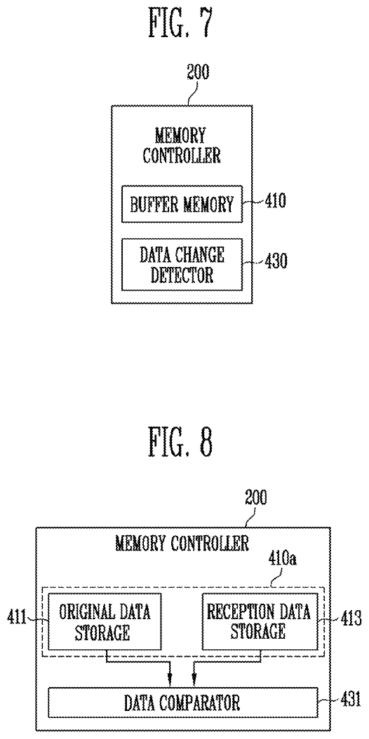

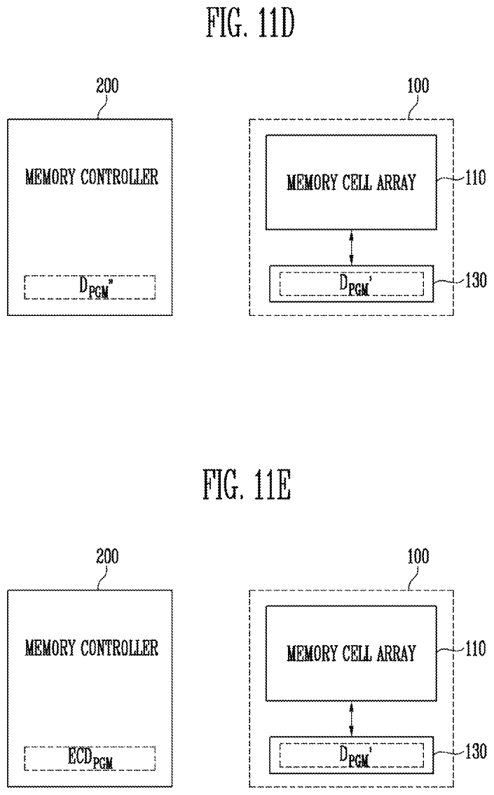

Embodiments of the buffer memory 410 and the data change detector 430 as shown in FIG. 7 will be described below with reference to FIGS. 8 and 10.

FIG. 8 is a block diagram illustrating an embodiment of the buffer memory 410 and the data change detector 430 of FIG. 7.

Referring to FIG. 8, a buffer memory 410a corresponding to the buffer memory 410 of FIG. 7 may include an original data storage 411 and a reception data storage 413. The data change detector 430 may include a data comparator 431.

The original data storage 411 may store the above-described original data. In other words, the original data storage 411 may store the original data corresponding to the program data output to the semiconductor memory device 100 for a program operation. The original data stored in the original data storage 411 may correspond to data, in which there are no bit flips, and may serve as reference data to be compared against the reception data.

The reception data storage 413 may store the above-described reception data. In other words, the reception data storage 413 may store reception data output from the reception data storage 130 of the semiconductor memory device 100 in response to the data output command and received by the memory controller 200. When the original data is transferred, or when the original data is stored in the page buffers of the read and write circuit 130, bit flips may occur. As a result, the reception data may include error bits.

The data comparator 431 may determine whether the reception data has been changed by comparing the original data stored in the original data storage 411 with the reception data stored in the reception data storage 413. More specifically, the data comparator 431 may compare the original data with the reception data in units of bits, e.g., on a bit-by-bit basis. When the reception data has one or more different bits with respect to the original data, it may be determined that one or more bit flips occurred in the reception data. On the other hand, when the reception data is the same as the original data, it may be determined that no bit flips occurred in the reception data.

Since both the original data and the reception data are generated during a program operation of the semiconductor memory device 100, the original data may be referred to as “first program data” and the reception data may be referred to as “second program data.” When the first program data is the same as the second program data, it may be determined that no bit flips occurred in the second program data relative to the first program data. On the other hand, when the first program data is different from the second program data, it may be determined that bit flips occurred.

According to an embodiment, the data comparator 431 may determine whether the reception or second data is different than the original or first data on the basis of a threshold value, which may be predetermined. For example, when the number of different bits between the reception data and the original data is less than a threshold value, it may be determined that the reception data is the same as the original data. On the other hand, when the number of different bits between the reception data and the original data is greater than or equal to the threshold value, it may be determined the reception data is different than the original data.

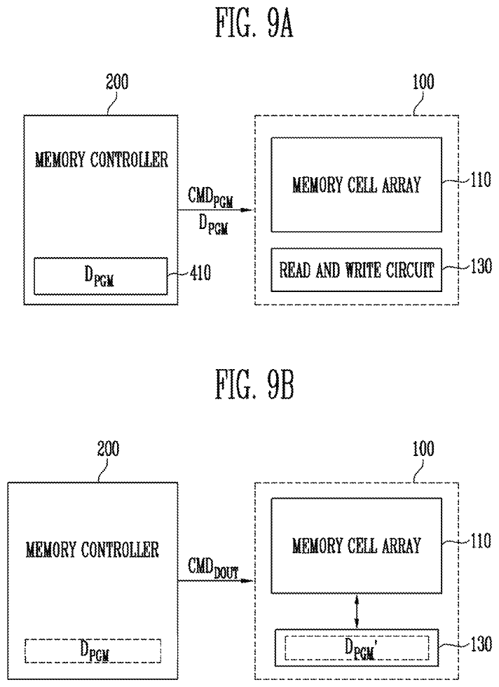

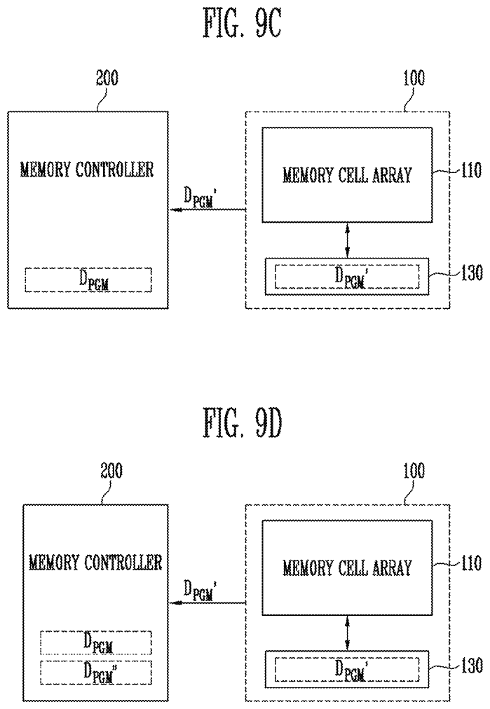

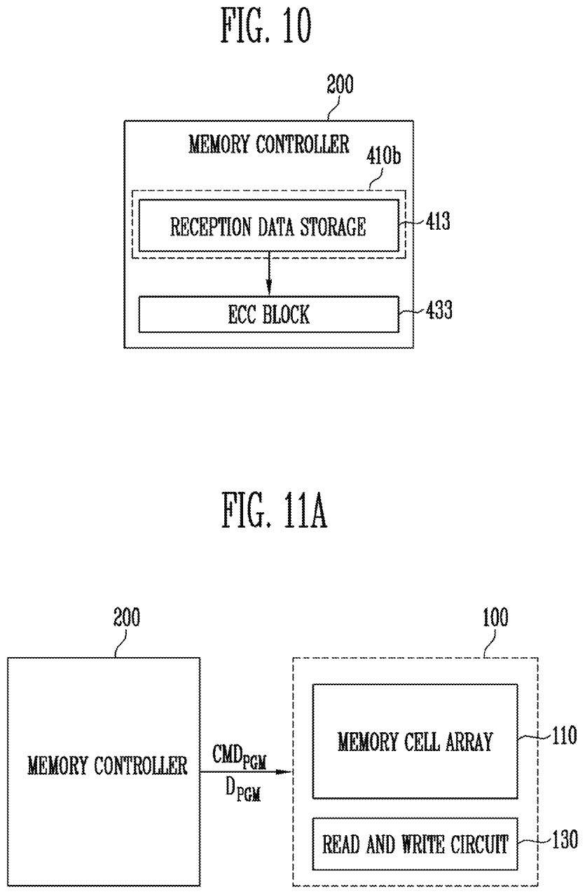

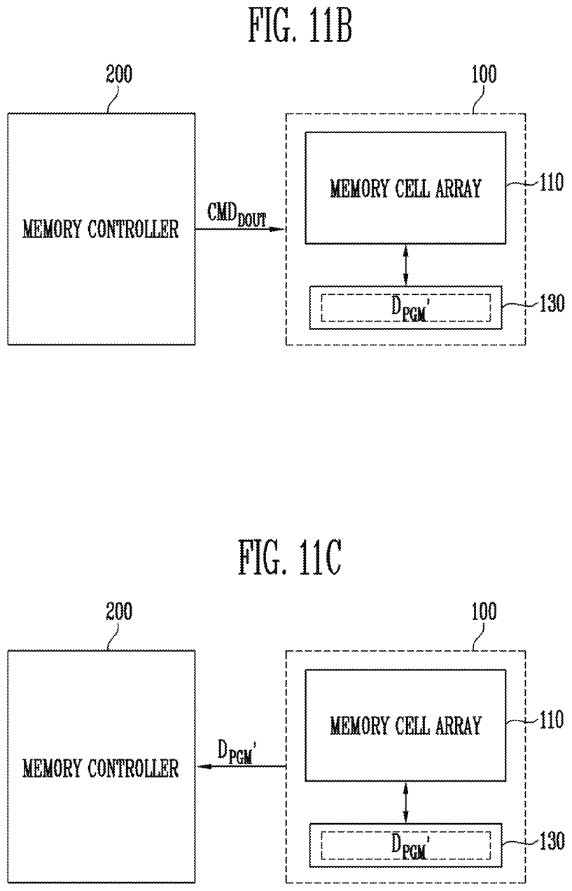

An operating method of the memory controller 200 shown in FIG. 8 will be described below with reference to FIGS. 9A to 9D.

FIGS. 9A to 9D are block diagrams illustrating operations of the memory controller 200 shown in FIG. 8.

First, referring to FIG. 9A, the memory controller 200 may transfer a program command CMD_{PGM} and program data D_{PGM} to the semiconductor memory device 100 for a program operation of the semiconductor memory device 100. The original data storage 411 of the memory controller 200 may store the program data D_{PGM}, i.e., original data.

Referring to FIG. 9B, program data D_{PGM} transferred to the semiconductor memory device 100 may be stored in page buffers PB of the read and write circuit 130. During this process, bit flips may have occurred. Therefore, for clarity, these two versions of the program data, which may be different, that is, D_{PGM′} stored in the read and write circuit 130 and the original data D_{PGM} are separately indicated. When bit flips have occurred, the program data D_{PGM′} stored in the read and write circuit 130 may be different from the original data D_{PGM}. On the other hand, when no bit flips have occurred, D_{PGM′} may be the same as D_{PGM}.

In FIG. 9B, the memory controller 200 may transfer a data output command CMD_{DOUT} to control the semiconductor memory device 100 to output the program data D_{PGM′} stored in the read and write circuit 130.

Referring to FIG. 9C, in response to the data output command CMD_{DOUT}, the program data D_{PGM′} stored in the read and write circuit 130 may be transferred to the memory controller 200.

Referring to FIG. 9D, the memory controller 200 may store the program data D_{PGM′}, as the reception data D_{PGM″}, in the reception data storage 413. Bit flips may be present in the program data D_{PGM″} when the program data D_{PGM′} is transferred from the read and write circuit 130 to the memory controller 200. Therefore, the program data D_{PGM″} stored in the reception data storage 413 and the program data D_{PGM′} stored in the read and write circuit 130 are separately indicated.

The data comparator 431 may determine whether data has been changed by comparing the original data D_{PGM} stored in the original data storage 411 with the reception data D_{PGM″} stored in the reception data storage 413.

More specifically, the data comparator 431 may compare the program data D_{PGM} corresponding to the original data with the program data D_{PGM″} corresponding to the reception data in units of bits, e.g., on a bit-by-bit basis. When the number of different bits is greater than or equal to a threshold value, it may be determined that the program data has been changed. On the other hand, when the number of different bits is less than the threshold value, it may be determined that the program data has not been changed. The threshold value may be predetermined.

As described above, the memory controller 200 according to an embodiment may receive the program data from the semiconductor memory device 100 and may compare the program data it receives (the reception data) with the original data. In addition, the memory controller 200 may determine whether the program data has been changed or not on the basis of different bits between the reception data and the original data. Therefore, the memory controller 200 according to an embodiment may determine whether bit flips have occurred in the program data as a result of the program data having been transferred to and stored in the semiconductor memory device 100, and, in the event that bit flips have occurred, may additionally determine whether the number of bit flips exceed a threshold value, and to perform subsequent operations on the basis of such determination. As a result, the operational reliability of the semiconductor memory device 100 and the storage device 1000 including the same may be improved.

FIG. 10 is a block diagram illustrating another embodiment of the buffer memory 410 and the data change detector 430 of FIG. 7.

Referring to FIG. 10, the buffer memory 410b may include a reception data storage 413. The data change detector 430 may include an error correction code (ECC) block 433. The reception data storage 413 of FIG. 10 may have substantially the same configuration as the reception data storage 413 of FIG. 8 and store reception data corresponding to program data received from the semiconductor memory device 100.

The ECC block 433 may perform an error correction operation on the reception data stored in the reception data storage 413. The ECC block 433 may detect the number of error bits included in the reception data by using an error correction code (ECC).

Since error bits are not present in the original data, the number of error bits included in the reception data may represent the number of bit flips. The ECC block 433 may count error bits included in the reception data and determine that the program data has been changed when the number of error bits is greater than or equal to a threshold value. On the other hand, when the number of error bits is less than the threshold value, the ECC block 433 may determine that the program data has not been changed. The threshold value may be predetermined.

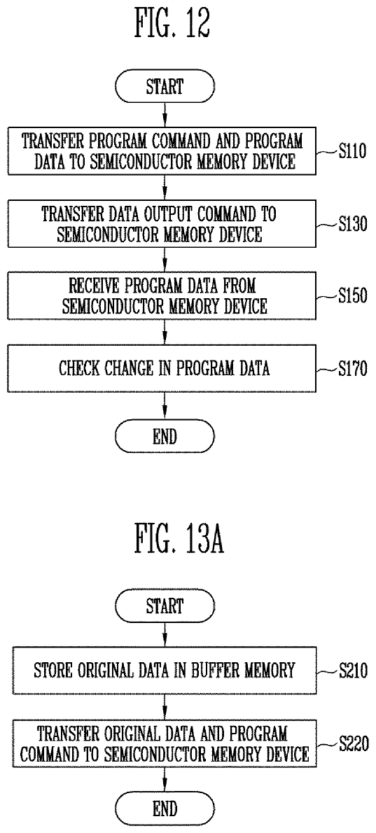

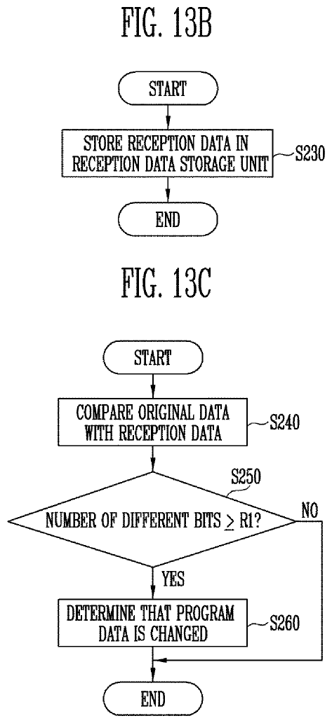

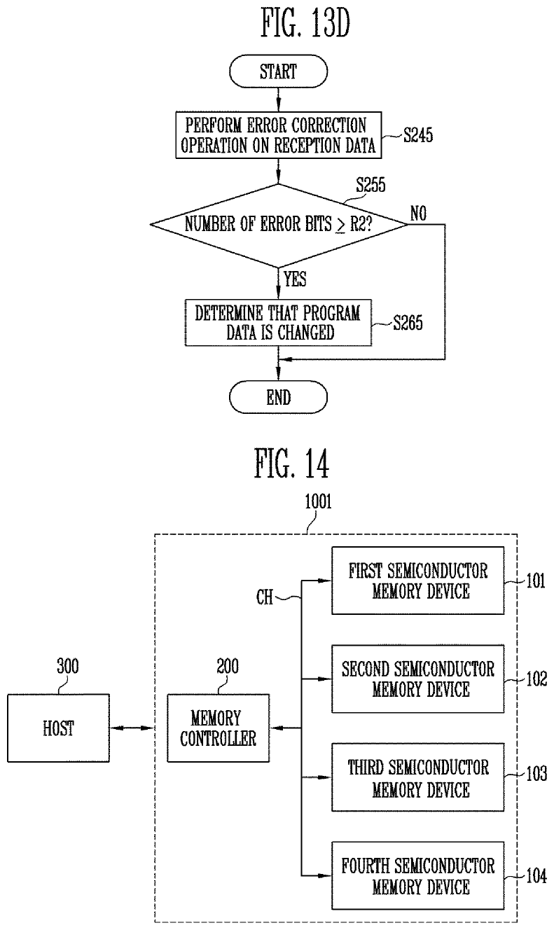

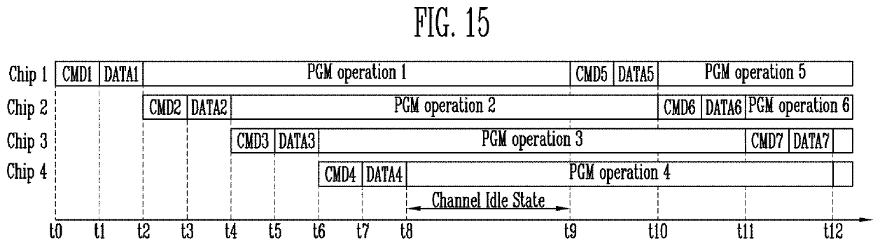

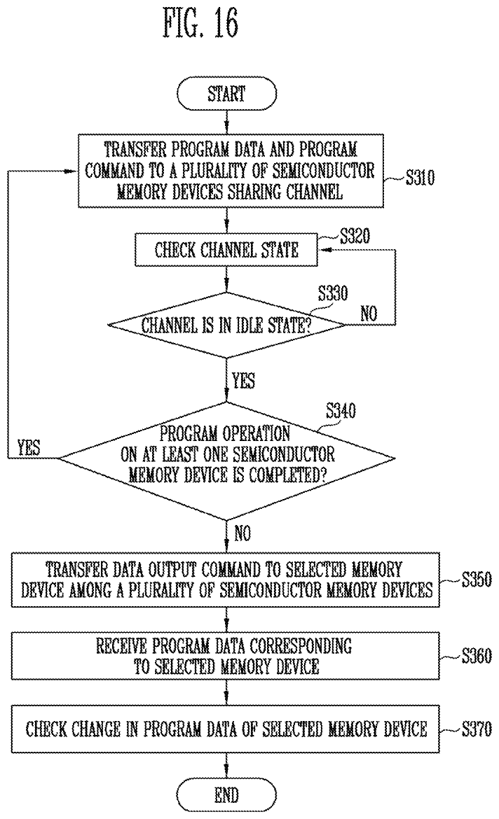

An operating method of the memory controller 200 shown in FIG. 10 will be described below with reference to FIGS. 11A to 11E.

FIGS. 11A to 11E are block diagrams illustrating operations of the memory controller 200 shown in FIG. 10.

First, referring to FIG. 11A, the memory controller 200 may transfer the program command CMD_{PGM} and the program data D_{PGM} to the semiconductor memory device 100 for a program operation of the semiconductor memory device 100.

Referring to FIG. 11B, the program data D_{PGM} transferred to the semiconductor memory device 100 may be stored in the page buffers PB of the read and write circuit 130. During this process, bit flips may occur in the program data D_{PGM′} that is stored in the semiconductor memory device. When bit flips occurred, the program data D_{PGM′} stored in the read and write circuit 130 may be different from the original data D_{PGM}. On the other hand, when no bit flips have occurred, D_{PGM′} may be the same as D_{PGM}.

In FIG. 11B, the memory controller 200 may transfer the data output command CMD_{DOUT} to control the semiconductor memory device 100 to output the program data D_{PGM′} stored in the read and write circuit 130.

Referring to FIG. 11C, in response to the data output command CMD_{DOUT}, the program data D_{PGM′} stored in the read and write circuit 130 may be transferred to the memory controller 200.

Referring to FIG. 11D, the memory controller 200 may receive the program data D_{PGM′} and store it as program data D_{PGM″}, i.e., reception data, in the reception data storage 413. Bit flips may occur in the program data D_{PGM″} when the program data D_{PGM′} is transferred from the read and write circuit 130 to the memory controller 200. Therefore, the program data D_{PGM″} stored in the reception data storage 413 and the program data D_{PGM′} stored in the read and write circuit 130 are separately indicated.

Referring to FIG. 11E, the ECC block 433 (shown in FIG. 10) may perform an error correction operation on the program data D_{PGM″} stored in the reception data storage 413. Error-corrected program data ECD_{PGM} may be generated by the error correction operation. In addition, through the error correction operation, the number of error bits in the program data D_{PGM″} corresponding to the reception data may be counted. The ECC block 433 may compare the number of error bits included in the program data D_{PGM″} with a threshold value, which may be predetermined. When the number of detected error bits is less than or equal to the threshold value, it may be determined that the program data D_{PGM″} has been changed relative to either or both of D_{PGM} and D_{PGM′}. On the other hand, when the number of different bits is less than the threshold value, it may be determined that the program data has not been changed.

As described above, the memory controller 200 according to an embodiment may receive back the program data, which is then reception data, transferred from the semiconductor memory device 100 for a program operation and may compare the received program data with the original data to perform an error correction operation. In addition, the memory controller 200 may determine whether the program data has been changed or not on the basis of error bits included in the reception data. Therefore, the memory controller 200 according to an embodiment may determine whether one or more bit flips have occurred in the program data as a result of being transferred to and stored in the semiconductor memory device 100, and, in the event bit flips have occurred, additionally determine whether the number of bit flips exceed a threshold value, and to perform subsequent operations on the basis of such determination. As a result, the operational reliability of the semiconductor memory device 100 and the storage device 1000 including the same may be improved.

FIG. 12 is a flowchart illustrating a method of operating the memory controller 200 according to an embodiment.

Referring to FIG. 12, the memory controller 200 according to an embodiment may include transferring the program command CMD_{PGM} and the program data D_{PGM} to the semiconductor memory device 100 at step S110, transferring the data output command CMD_{DOUT} to the semiconductor memory device 100 at step S130, receiving the program data D_{PGM″} from the semiconductor memory device 100 at step S150, and checking whether there has been any change in the program data at step S170.

At step S110, as described above with reference to FIG. 9A or FIG. 1.1A, the program command CMD_{PGM} and the program data D_{PGM} may be transferred to the semiconductor memory device 100 from the memory controller 200. An embodiment of step S110 will be described below with reference to FIG. 13A.

At step S130, as described above with reference to FIG. 9A or FIG. 11B, the data output command CMD_{DOUT} may be transferred from the memory controller 200 to the semiconductor memory device 100. In response to the data output command CMD_{DOUT}, the semiconductor memory device 100 may output the program data D_{PGM′} stored in the page buffers of the read and write circuit 130.

At step S150, as described above with reference to FIG. 9A or FIG. 11C, the program data D_{PGM′} may be transferred from the semiconductor memory device 100 to the memory controller 200. An embodiment of step S150 will be described below with reference to FIG. 13B.

At step S170, as described above with reference to FIG. 9A or FIGS. 11D and 11E, a change in the program data D_{PGM″} may be determined. An embodiment of step S170 will be described below with reference to FIGS. 13C and 13D.

FIG. 13A is a flowchart illustrating an embodiment of step S110 of FIG. 12.

Referring to FIG. 13A, step S110 of FIG. 12 may include storing the original data in the buffer memory at step S210 and transferring the original data and the program command to the semiconductor memory device at step S220.

At step S210, the program data D_{PGM} corresponding to the original data may be stored in the original data storage 411 shown in FIG. 8.

At step S220, as described above with reference to FIG. 9A and FIG. 11A, the program command CMD_{PGM} and the program data D_{PGM} corresponding to the original data may be transferred to the semiconductor memory device 100.

FIG. 13B is a flowchart illustrating an embodiment of step S150 of FIG. 12.

Referring to FIG. 13B, step S150 may include storing the reception data received by the memory controller 200 in the reception data storage 413 at step S230.

FIG. 13C is a flowchart illustrating an embodiment of step S170 of FIG. 12.

Referring to FIG. 13C, step S170 may include comparing the original data with the reception data at step S240, comparing the number of different bits between the original data and the reception data with a threshold value R1 at step S250, and determining that the program data has been changed when the number of different bits is greater than or equal to the threshold value R1 at step S260. R1 may be predetermined.

At step S240, as shown in the embodiment of FIG. 9D, the number of different bits may be counted by comparing the program data D_{PGM} stored in the original data storage 411 with the program data D_{PGM″} stored in the reception data storage 410a.

As a result of the comparison at step S250, when the number of different bits is greater than or equal to the threshold value R1 (that is, “YES” at step S250), the process flow may proceed to step S260 to determine that the program data has been changed.

As a result of the comparison at step S250, when the number of different bits is less than the threshold value R1 (that is, “NO” at step S250), it may be determined that the program data has not been changed, and the processes may be terminated.

FIG. 13D is a flowchart illustrating another embodiment of step S170 of FIG. 12.

Referring to FIG. 13D, step S170 may include performing an error correction operation on the reception data at step S245, comparing the number of error bits as a result of the error correction operation with a threshold value R2 at step S255, and determining that the program data has been changed when the number of error bits is greater than or equal to the threshold value R2 at step S265.

At step S245, as in the embodiment shown in FIGS. 11D and 11E, an error correction operation may be performed on the program data D_{PGM″} stored in the reception data storage 413 to count error bits.

As a result of the comparison at step S255, when the number of error bits in the program data D_{PGM″} is greater than or equal to the threshold value R2 (that is, “YES” at step S255), the process flow may proceed to step S265 to determine that the program data has been changed.

As a result of the comparison at step S255, when the number of error bits is less than the threshold value R2 (that is, “NO” at step S255), it may be determined that the program data has not been changed, and the processes may be terminated.

FIG. 14 is a block diagram illustrating a storage device 1001 according to an embodiment.

Referring to FIG. 14, the storage device 1001 communicating the host 300 may include a plurality of semiconductor memory devices 101, 102, 103, and 104 and the memory controller 200. The plurality of semiconductor memory devices 101, 102, 103, and 104 may share a single channel CH and communicate with the memory controller 200. Since the plurality of semiconductor memory devices 101, 102, 103, and 104 share one channel, when one of the semiconductor memory devices exchanges data with the memory controller 200, the other semiconductor memory devices may not be able to communicate with the memory controller 200.

In the embodiment of FIG. 14, it is illustrated that the four semiconductor memory devices 101, 102, 103, and 104 share one channel and communicate with the memory controller 200. However, this is merely an example. More generally, the number of semiconductor memory devices that share one channel and communicate with the memory controller 200 may be two or more. In addition, the memory controller may communicate with the semiconductor memory devices through a plurality of channels.

The memory controller 200 included in the storage device 1001 of FIG. 14 may include the buffer memory 410 and the data change detector 430 as shown in FIG. 7. According to an embodiment, as shown in FIG. 8, the buffer memory 410 may include the original data storage 411 and the reception data storage 413, and the data change detector 430 may include the data comparator 431. In another embodiment, as shown in FIG. 10, the buffer memory 410 may include the reception data storage 413, and the data change detector 430 may include the ECC block 433.

As shown in FIG. 14, to increase efficiency of a program operation in the structure where the plurality of semiconductor memory devices 101, 102, 103, and 104 share one channel, an interleaving scheme may be used. An interleaving scheme in a program operation will be described with reference to FIG. 15.

FIG. 15 is a timing diagram illustrating operations of the storage device 1002 shown in FIG. 14.

Referring to FIG. 15, a program operation on the four semiconductor memory devices 101, 102, 103, and 104 as shown in FIG. 14 is illustrated. In FIG. 15, the first, second, third, and fourth semiconductor memory devices 101, 102, 103, and 104 are illustrated as Chip 1, Chip 2, Chip 3, and Chip 4, respectively.

First, at time t0, a first program command CMD1 may start to be transferred to the first semiconductor memory device 101 (Chip 1). At time t1, the first program command CMD1 may be completely transferred and first program data DATA1 may start to be transferred. At time t2, the first program data DATA1 may be completely transferred, and a first program operation PGM operation 1 of the first semiconductor memory device 101 (Chip 1) may start to be performed.

During the period between t0 and t2, the first semiconductor memory device 101 (Chip 1) may receive the first program command CMD1 and the first program data DATA1 from the memory controller 200. Since a channel is shared by the first to fourth semiconductor memory devices, the second to fourth semiconductor memory devices 102 to 104 (Chip 2 to Chip 4) may not be able to communicate with the memory controller 200 during the period from t0 to t2.

At time t2, the first program data DATA1 may be completely transferred and a second program command CMD2 may start to be transferred to the second semiconductor memory device 102 (Chip 2). At time t3, the second program command CMD2 may be completely transferred and second program data DATA2 may start to be transferred. At time t4, the second program data DATA2 may be completely transferred, and a second program operation PGM operation 2 of the second semiconductor memory device 102 (Chip 2) may start to be performed.

During the period from t2 to t4, the first semiconductor memory device 102 (Chip 2) may receive the second program command CMD2 and the second program data DATA2 from the memory controller 200. Since the channel is shared by the first to fourth semiconductor memory devices, during the period from t2 to t4, the third and fourth semiconductor memory devices 103 and 104 (Chip 3 and Chip 4) may not be able to communicate with the memory controller 200.

At time t4, the second program data DATA2 may be completely transferred and a third program command CMD3 may start to be transferred to the third semiconductor memory device 103 (Chip 3). At time t5, the third program command CMD3 may be completely transferred and third program data DATA3 may start to be transferred. At time t6, the third program data DATA3 may be completely transferred, and a third program operation PGM operation 3 of the third semiconductor memory device 103 (Chip 3) may start to be performed.

During the period between t4 and t6, the third semiconductor memory device 103 (Chip 3) may receive the third program command CMD3 and the second program data DATA3 from the memory controller 200. Since the channel is shared by the first to fourth semiconductor memory devices, during the period from period t4 to t6, the fourth semiconductor memory devices 104 (Chip 4) may not be able to communicate with the memory controller 200.

At time t6, the third program data DATA3 may be completely transferred and a fourth program command CMD4 may start to be transferred to the second semiconductor memory device 104 (Chip 4). At time t7, the fourth program command CMD4 may be completely transferred and fourth program data DATA4 may start to be transferred. At time t8, the fourth program data DATA4 may be completely transferred, and a fourth program operation PGM operation 4 of the fourth semiconductor memory device 104 (Chip 4) may start to be performed.

During the period from t0 to t8, the program command or the program data may be transferred to at least one of the first to fourth semiconductor memory devices 101 to 104 (Chip 1 to Chip 4) through the channel. Therefore, during the period from t0 to t8, the channel may be used to transfer data between one of the first to fourth semiconductor memory devices 101 to 104 and the memory controller 200.

At time t9, the first program operation may be completed and a fifth program command CMD5 and fifth program data DATA5 may be transferred to the first semiconductor memory device 101 (Chip 1). In addition, at time t10, the fifth program data DATA5 may be completely transferred and a sixth program command CMD6 and sixth program data DATA6 may be transferred to the second semiconductor memory device 102 (Chip 2). In addition, at time t11, the sixth program data DATA6 may be completely transferred and a seventh program command CMD7 and seventh program data DATA7 may be transferred to the third semiconductor memory device 103 (Chip 3). Similarly, after time t12, a subsequent program command and subsequent program data may be transferred to the fourth semiconductor memory device 104 (Chip 4) through the channel. In other words, during a period from t9 to t12, a program command or program data may be transferred to at least one of the first to fourth semiconductor memory devices 101 to 104 (Chip 1 to Chip 4) through the channel. Therefore, during the period from t9 to t12, the channel may be used to transfer data between one of the first to fourth semiconductor memory devices 101 to 104 and the memory controller 200.

In the interleaved program operation method as shown in FIG. 15, during the period from t8 to t9, each of the first to fourth semiconductor memory devices 101 to 104 (Chip 1 to Chip 4) may be performing the program operation, and the channel may be in an idle state. Therefore, when a change of the program data is determined during the period from t8 to t9 corresponding to a channel idle state, such change may be determined without consuming additional operation time.

More specifically, in a storage device according to an embodiment, the plurality of semiconductor memory devices 101 to 104 (Chip 1 to Chip 4) may share one channel CH and communicate with the memory controller 200. When a program operation is performed on the plurality of semiconductor memory devices 101 to 104, the memory controller 200 may transfer a data output command to one of the semiconductor memory devices 101 to 104 during an idle time of the channel CH.

In other words, in the timing diagram of FIG. 15, during the period from t8 to t9, the memory controller 200 may output a data output command to at least one of the semiconductor memory devices 101 to 104.

When it takes a relatively long time to perform the program operation on each of the first to fourth semiconductor memory devices 101 to 104, the period from t8 to t9 when the channel idle state continues may be longer. By transferring the data output command to a relatively large number of semiconductor memory devices, whether bit flips occur in the program data transferred to each of the semiconductor memory devices occur may be determined.

On the other hand, when it takes a relatively short time to perform the program operation on each of the first to semiconductor memory devices 101 to 104 (Chip 1 to Chip 4), the period from t8 to t9 when the channel idle state continues may be shorter. By transferring a data output command to a relatively small number of semiconductor memory devices, for example, a single semiconductor memory device, whether bit flips occur in the program data transferred to the corresponding semiconductor memory device occur may be determined.

During the channel idle time, the data output command may be transferred to at least one of the first to semiconductor memory devices 101 to 104 (Chip 1 to Chip 4) and whether bit flips have occurred may be determined by analyzing the program data received by the memory controller 200 as described above with reference to FIGS. 9B to 9D or FIGS. 11D and 11E.

FIG. 16 is a flowchart illustrating a method of operating the storage device 1001 shown in FIG. 14.

Referring to FIG. 16, the method of operating the storage device 1001 may include transferring program data and a program command to the plurality of semiconductor memory devices 101 to 104 (Chip 1 to Chip 4) sharing the channel CH at step S310, checking a state of the channel CH at step S320, determining, as a result of checking the state of the channel CH at step S330, whether a program operation of at least one of the semiconductor memory devices is completed when the channel CH is in an idle state at step S340, transferring a data output command to the selected semiconductor memory device, among the plurality of semiconductor memory devices 101 to 104 (Chip 1 to Chip 4), when each of the semiconductor memory devices 101 to 104 is performing a program operation at step S350, receiving program data corresponding to the selected semiconductor memory device at step S360, and checking a change in the program data of the selected semiconductor memory device at step S370.

At step S310, program data and a program command may be transferred to the plurality of semiconductor memory devices 101 to 104 (Chip 1 to Chip 4) sharing the channel CH. For example, during the period from t0 to t8 of FIG. 15, program data and a program command may be transferred to each of the plurality of semiconductor memory devices 101 to 104 sharing the channel CH.

A channel state may be checked at step S320. When the channel CH is not in an idle state as a result of the check at step S330 (that is, “NO” at step S330), the process flow may proceed back to step S320. For example, during the period from t0 to t8 of FIG. 15, since the channel CH is occupied, the process flow may proceed to step S320 as a result of determination at step S330.

The process flow may proceed to step S340 when the channel is in the idle state as a result of the check at step S330 (that is, “YES” at step S330). Even when the channel is in the idle state, if the program operation of one of the semiconductor memory devices 101 to 104 (Chip 1 to Chip 4) coupled to the channel CH is completed, the process flow may proceed to step S310 and a subsequent program command and subsequent program data may be transferred to the semiconductor memory device on which the program operation is completed. For example, since the program operation on the first semiconductor memory device 101 (Chip 1) is completed at time t9 of FIG. 15, the fifth program command CMD5 and the fifth program data DATA5 may be transferred to the first semiconductor memory device 101 through the channel CH.

As a result of determination at step S340, when it is determined that each of the semiconductor memory devices 101 to 104 (Chip 1 to Chip 4) coupled to the channel CH is performing a program operation, the process flow may proceed to step S350. In other words, since it is in the channel idle state during the period from t8 to t9, a data output command may be transferred to the selected semiconductor memory device among the semiconductor memory devices 101 to 104 coupled to the channel CH.

At step S350, the data output command may be transferred to one semiconductor memory device. However, the data output command may be transferred to two or more semiconductor memory devices, or all semiconductor memory devices coupled to the channel. Since the semiconductor memory devices share the channel, when the data output command is transferred to two or more of the semiconductor memory devices, the data output command may be sequentially transferred to the corresponding semiconductor memory devices.

At step S360, program data may be received from the semiconductor memory device to which the data output command is transferred. At step S370, whether or not the program data of the selected semiconductor memory device has been changed may be determined. According to an embodiment, as described above with reference to FIG. 8 and FIGS. 9A to 9D, whether program data has been changed may be determined by comparing original data and reception data. In another embodiment, as described above with reference to FIG. 10 and FIGS. 11A to 11E, whether the program data has been changed may be determined by counting error bits by performing an error correction operation on the reception data.

FIG. 17 is a block diagram illustrating an embodiment of the memory controller 200 shown in FIG.

Referring to FIG. 17, the memory controller 200 may be coupled between the semiconductor memory device 100 and a host. The semiconductor memory device 100 may be the semiconductor memory device described with reference to FIG. 2. The memory controller 200 may correspond to the memory controller 200 of FIG.

The memory controller 200 may be configured to access the semiconductor memory device 100 at the request of the host. For example, the memory controller 200 may control a read operation, a program operation, an erase operation, and/or a background operation of the semiconductor memory device 100. The memory controller 200 may be configured to provide an interface between the semiconductor memory device 100 and the host. The memory controller 200 may be configured to drive firmware for controlling the semiconductor memory device 100.

The memory controller 200 may include a random access memory (RAM) 210, a processor 220, a host interface 230, a memory interface 240, and an error correction block 250. The RAM 210 may be used as at least one of an operation memory of the processor 220, a cache memory between the semiconductor memory device 100 and the host, and a buffer memory between the semiconductor memory device 100 and the host. In addition, the RAM 210 may serve as a command queue for temporarily storing commands to be transferred to the semiconductor memory device 100. According to an embodiment, the buffer memory 410 of FIG. 7 may be composed of the RAM 210 of FIG. 17.

The processor 220 may control general operations of the memory controller 200. According to an embodiment, the data comparator 431 of FIG. 8 may be composed of firmware executed by the processor 220.

The host interface 230 may include a protocol for exchanging data between the host and the memory controller 200. For example, the memory controller 200 may communicate with the host through one or more various protocols such as a universal serial bus (USB) protocol, a multimedia card (MMC) protocol, a peripheral component interconnection (PCI) protocol, a PCI-express (PCI-E) protocol, an advanced technology attachment (ATA) protocol, a serial-ATA protocol, a parallel-ATA protocol, a small computer small interface (SCSI) protocol, an enhanced small disk interface (ESDI) protocol, an integrated drive electronics (IDE) protocol, a private protocol, etc.

The memory interface 240 may interface with the semiconductor memory device 100. For example, the memory interface includes a NAND interface or a NOR interface.

The error correction block 250 may use an error correcting code (ECC) to detect and correct an error in data received from the semiconductor memory device 100. The processor 220 may control a read voltage according to an error detection result of the error correction block 250 and control the semiconductor memory device 100 to perform re-read. According to an embodiment, the ECC block of FIG. 10 may be composed of the ECC block 250 of FIG. 17.

The memory controller 200 and the semiconductor memory device 100 may be integrated into a single semiconductor device. According to an embodiment, the memory controller 200 may be integrated into a single semiconductor device to form a memory card such as a personal computer memory card international association (PCMCIA), a compact flash card (CF), a smart media card (SM or SMC), a memory stick multimedia card (MMC, RS-MMC, or MMCmicro), a SD card (SD, miniSD, microSD, or SDHC), and/or a universal flash storage (UFS).

The memory controller 200 and the semiconductor memory device 100 may be integrated into a single semiconductor device to form a solid state drive (SSD). The solid state drive SSD may include a storage device configured to store data in a semiconductor memory. When the storage device including the memory controller 200 and the semiconductor memory device 100 serves as a solid state drive (SSD), operational speed of the host coupled to the storage device may be significantly improved.

In another example, the storage device including the memory controller 200 and the semiconductor memory device 100 may be provided as one of various elements of an electronic device such as a computer, a ultra-mobile PC (UMPC), a workstation, a net-book, a personal digital assistants (PDA), a portable computer, a web tablet, a wireless phone, a mobile phone, a smart phone, an e-book, a portable multimedia player (PMP), a game console, a navigation device, a black box, a digital camera, a 3-dimensional television, a digital audio recorder, a digital audio player, a digital picture player, a digital picture recorder, a digital video recorder, a device capable of transmitting/receiving information in an wireless environment, one of various devices for forming a home network, one of various electronic devices for forming a computer network, one of various electronic devices for forming a telematics network, an RFID device, or one of various elements for forming a computing system, or the like.

In an embodiment, the semiconductor memory device 100 or the storage device including the same may be embedded in packages in various forms. For example, the semiconductor memory device 100 or the storage device may be embedded in a package on package (PoP), ball grid arrays (BGAs), chip scale packages (CSPs), a plastic leaded chip carrier (PLCC), a plastic dual in line package (PDIP), a die in waffle pack, a die in wafer form, a chip on board (COB), a ceramic dual in line package (CERDIP), a plastic metric quad flat pack (MQFP), a thin quad flatpack (TQFP), a small outline (SOIL), a shrink small outline package (SSCP), a thin small outline (TSOP), a thin quad flatpack (TQFP), a system in package (SIP), a multichip package (MCP), a wafer-level fabricated package (WFP), a wafer-level processed stack package (WSP), or the like.

FIG. 18 is a block diagram illustrating an application example of the storage device 1000 of FIG.

Referring to FIG. 18, a storage device 2000 may include a semiconductor memory device 2100 and a controller 2200 according to an embodiment. The semiconductor memory device 2100 may include a plurality of semiconductor memory chips. The plurality of semiconductor memory chips may be divided into a plurality of groups.

In FIG. 18, it is illustrated that kth groups communicate with the controller 2200 through first to kth channels CH1 to CHk respectively. Each of the semiconductor memory chips may be configured and operated in the same manner as the semiconductor memory device 100 described above with reference to FIG. 2.

Each group may be configured to communicate with the controller 2200 through a single common channel. The controller 2200 may be configured in substantially the same manner as the memory controller 200 described with reference to FIG. 18, and configured to control the plurality of memory chips of the semiconductor memory device 2100 through the plurality of first to kth channels CH1 to CHk.

FIG. 19 is a block diagram illustrating a computing system 3000 including the storage device 2000 described with reference to FIG. 18.

The computing system 3000 may include a central processing unit (CPU) 3100, a Random Access Memory (RAM) 3200, a user interface 3300, a power supply 3400, a system bus 3500, and the storage device 2000.

The storage device 2000 may be electrically coupled to the CPU 3100, the RAM 3200, the user interface 3300, and the power supply 3400 through the system bus 3500. Data provided through the user interface 3300 or processed by the CPU 3100 may be stored in the storage device 2000.

FIG. 19 illustrates that the semiconductor memory device 2100 is coupled to the system bus 3500 through the controller 2200. However, the semiconductor memory device 2100 may be directly coupled to the system bus 3500. The functions of the controller 2200 may be performed by the CPU 3100 and the RAM 3200.

In FIG. 19, it is illustrated that the storage device 2000 described with reference to FIG. 18 is provided. However, the memory controller 2000 may be replaced by the storage device including the memory controller 200 and the semiconductor memory device 100 as described above with reference to FIG. 17.

According to an embodiment, a memory controller having improved reliability and a storage device including the same may be provided.

According to another embodiment, an operating method of a memory controller having improved reliability may be provided.

In the above-discussed embodiments, all steps may be selectively performed or skipped. In addition, the steps in each embodiment may not always be performed in regular order. Furthermore, the embodiments disclosed in the present specification and the drawings aims to help those skilled in this art more clearly understand the present disclosure rather than to limit the bounds of the present disclosure. In other words, those skilled in the art to which the present disclosure belongs will be able to easily understand that various modifications are possible based on the technical scope of the present disclosure. It will be apparent to those skilled in the art in light of the present disclosure that various modifications can be made to the above-described embodiments of the present invention without departing from the spirit or scope of the invention. Thus, it is intended that the present disclosure cover all such modifications provided they come within the scope of the appended claims and their equivalents.

What is claimed is:

1. A memory controller transferring first program data to a semiconductor memory device to control a program operation of the semiconductor memory device, the memory controller comprising:
a buffer memory storing second program data received from the semiconductor memory device after the first program data is transferred; and
a data change detector determining whether the first program data transferred to the semiconductor memory device is changed by analyzing the second program data.

2. The memory controller of claim 1,
wherein the memory controller transfers a data output command to the semiconductor memory device after transferring the first program data to the semiconductor memory device, and
wherein the memory controller receives the second program data from the semiconductor memory device in response to the data output command.

3. The memory controller of claim 2, wherein the buffer memory comprises:
an original data storage storing the first program data; and
a reception data storage storing the second program data.

4. The memory controller of claim 3, wherein the data change detector includes a data comparator comparing the first program data with the second program data.

5. The memory controller of claim 4, wherein the data comparator determines that the data is changed when a number of different bits between the first program data and the second program data is greater than or equal to a first threshold value.

6. The memory controller of claim 2,
wherein the buffer memory comprises a reception data storage storing the second program data, and
wherein the data change detector comprises an error correction code (ECC) block performing an error correction operation on the second program data.

7. The memory controller of claim 6, wherein the ECC block counts error bits included in the second program data and determines that the data is changed when a number of error bits is greater than or equal to a second threshold value.

8. A storage device, comprising:
a first semiconductor memory device;
a second semiconductor memory device sharing a channel with the first semiconductor memory device;
a memory controller controlling the first and second semiconductor memory devices through the channel,
wherein the memory controller is configured to:
transfer a first program command and first program data to the first semiconductor memory device,
transfer a second program command and second program data to the second semiconductor memory device, and
output a data output command to one of the first and second semiconductor memory devices during an idle time of the channel when a first program operation of the first semiconductor memory device and a second program operation of the second semiconductor memory device are performed in response to the first program command and the second program command, respectively.

9. The storage device of claim 8, wherein the memory controller comprises:
a buffer memory storing third program data corresponding to the data output command; and
a data change detector determining whether data is changed by analyzing the third program data.

10. The storage device of claim 9, wherein the buffer memory comprises:
an original data storage storing at least one of the first program data and the second program data; and
a reception data storage storing the third program data.

11. The storage device of claim 10,
wherein the memory controller transfers the data output command to the first semiconductor memory device,
wherein the original data storage stores the third program data received from the first semiconductor memory device, and
wherein the data change detector includes a data comparator comparing the first program data with the third program data to determine that the data is changed when a number of different bits is greater than or equal to a first threshold value.

12. The storage device of claim 10,
wherein the memory controller transfers the data output command to the second semiconductor memory device,
wherein the original data storage stores the third program data received from the second semiconductor memory device, and
wherein the data change detector includes a data comparator comparing the second program data with the third program data to determine that the data is changed when a number of different bits is greater than or equal to a first threshold value.

13. The storage device of claim 9,
wherein the buffer memory comprises a reception data storage storing the third program data, and
wherein the data change detector counts error bits included in the third program data and determines that the data is changed when a number of error bits is greater than or equal to a second threshold value.

14. A method of operating a memory controller, the method comprising:
transferring a program command and first program data to a semiconductor memory device;
transferring a data output command to the semiconductor memory device;
receiving second program data from the semiconductor memory device; and
determining whether first program data transferred to the semiconductor memory device is changed by analyzing the second program data.

15. The method of claim 14, wherein the determining whether the program data is changed comprises:
comparing the first program data with the second program data; and
determining that the program data is changed when a number of different bits between the first program data and the second program data is greater than or equal to a first threshold value.

16. The method of claim 14, wherein the determining whether the program data is changed comprises:
determining an error correction operation on the second program data; and
determining that the program data is changed when a number of detected error bits is greater than or equal to a second threshold value as a result of performing the error correction operation.

17. A method of operating a memory controller controlling operations of a plurality of semiconductor memory devices sharing a channel, the method comprising:
transferring program data and a program command corresponding to each of the plurality of semiconductor memory devices;
checking a state of the channel;
transferring a data output command to one of the plurality of semiconductor memory devices when the channel is in an idle state;
receiving program data corresponding to the data output command; and
checking whether the program data transferred to the one of the semiconductor memory devices is changed by analyzing the program data.

18. The method of claim 17, wherein the data output command is transferred only when each of the plurality of semiconductor memory devices sharing the channel performs a program operation.

19. The method of claim 18, wherein the checking includes:
comparing the program data of the receiving operation (reception data) with the program data of the transferring operation (original data); and
determining that the program data is changed by comparing the reception data with original data when a number of different bits between the reception data and the original data is greater than or equal to a first threshold value.

20. The method of claim 18, wherein the checking includes:
performing an error correction operation on the program data; and
determining that the program data is changed when a number of error bits is greater than or equal to a second threshold value as a result of the error correction operation.

21. A memory system comprising:
a plurality of memory devices sharing a channel; and
a controller configured to control, through the channel, the memory devices to program plural pieces of data based on an interleaving scheme,
wherein the controller detects bit-flips in the data received back from the memory devices to provide corrected pieces of the data to the memory devices, respectively, while the memory devices are programming the data and the channel is idle.
